(19) United States
(12) Patent Application Publication
(10) Pub. No.: US 2015/0014909 A1
(43) Pub. Date: Jan. 15, 2015

(54) PORTABLE MACHINING APPARATUS

(71) Applicant: POWERHOUSE MECHANICAL REPAIR, INC., Charlotte, NC (US)

(72) Inventors: John VanNess Andrews, JR., Midland, NC (US); Robert C. Grice, Charlotte, NC (US); Earl Harry Cooper, Kings Mountain, NC (US); David Rycyk, Charlotte, NC (US)

(21) Appl. No.: 14/329,278

(22) Filed: Jul. 11, 2014

Related U.S. Application Data
(60) Provisional application No. 61/845,735, filed on Jul. 12, 2013.

(51) Int. Cl. B23Q 1/25; B23Q 1/00; B23Q 1/01

(52) U.S. Cl. CPC B23Q 1/25; B23Q 1/015; B23Q 1/0054
USPC 269/58; 269/55

(57) ABSTRACT

Embodiments of the invention are directed to a portable machining apparatus comprising: a frame, a rotary table operatively coupled to the frame; a cross slide operatively coupled to the frame; and wherein the cross slide is configured for operative coupling to live tooling, wherein the live tooling may be adjustable in one or more axes by adjusting the frame or the cross slide for machining a component secured to the rotary table.

### PRIORITY CLAIM UNDER 35 U.S.C. §119(e)

This Application claims priority to U.S. Provisional Application No. 61/845,735 filed Jul. 12, 2013 also entitled “PORTABLE MACHINING APPARATUS”, and which is assigned to the assignee hereof and hereby expressly incorporated by reference herein.

### FIELD

The application relates to the field of portable machining apparatuses.

### BACKGROUND

Repairing equipment on site reduces costs and improves efficiency.

### BRIEF SUMMARY

Embodiments of the invention relate to a portable machining apparatus that may be positioned in one or more axes (e.g., X, Y, and Z) to machine various equipment components. The portable machining apparatus may be utilized to repair damaged or worn equipment components on site without having to send components to off-site for repair or replacement machining. Particularly, in one embodiment the portable machining apparatus may be an oil seal machining apparatus that is utilized on site to machine the diameters and teeth of oil seals used in turbines (e.g., turbine power, turbine engines, or the like). By repairing equipment onsite, the equipment owner may save both time and money as opposed to shipping large equipment offsite for customized repairs. The present invention uniquely has the ability to perform millings, borings, drillings, or other functions in repairing a wide variety of types and sizes of equipment. Other examples of serviceable equipment outside of oil seals include, but are not limited to, air seals, hydrogen seals, hydraulic steals, equipment housings, static or dynamic parts, or other like equipment components.

One aspect, the present invention is directed to a portable machining apparatus comprising: a frame, a rotary table operatively coupled to the frame; a cross slide operatively coupled to the frame; and wherein the cross slide is configured for operative coupling to live tooling, wherein the live tooling may be adjustable in one or more axes by adjusting the frame or the cross slide for machining a component secured to the rotary table.

In some embodiments, the frame comprises a base portion and a top portion that are adjustable with respect to each other in a vertical axis.

In some embodiments, the frame comprises adjustable feet.

In some embodiments, the frame comprises a bearing drive for adjusting the rotary table.

In some embodiments, the base portion comprises a plurality of posts extending substantially vertically from the base portion.

In some embodiments, the top portion comprises a plurality of collars that are operatively coupled to the plurality of post for sliding in the generally vertical direction.

In some embodiments, the plurality of collars comprises a plurality of frame locks for securing the top portion to the base portion.

In some embodiments, the plurality of frame locks comprises a pin or a threaded bolt that makes engages the post.

In some embodiments, the frame further comprises frame adjustments that are operatively coupled to, and extend substantially vertically from, the base portion, and are operatively coupled to the top portion to allow for adjustability of the top portion with respect to the base portion in the vertical direction.

In some embodiments, the frame adjustments comprise threaded rods.

In some embodiments, the rotary table comprises a plurality of jaw chucks to secure the component.

In some embodiments, the rotary table comprises an angle plate to secure the component.

In some embodiments, the cross slide is adjustable along at least one axis of the top portion of the frame.

In some embodiments, the tooling is adjustable along at least one axis with respect to the cross slide.

In some embodiments, the tooling comprises an adjustment in one or more axes.

### BRIEF DESCRIPTION OF THE DRAWINGS

Having thus described embodiments of the invention in general terms, reference will now be made to the accompanying drawings, where:

FIG. 1A illustrates a perspective view of a portable machining apparatus, in accordance with embodiments of the present invention;

FIG. 1B illustrates another perspective view of a portable machining apparatus, in accordance with embodiments of the present invention;

FIG. 1C illustrates a side view of a portable machining apparatus, in accordance with embodiments of the present invention;

FIG. 1D illustrates a top view of a portable machining apparatus, in accordance with embodiments of the present invention;

FIG. 2 illustrates a perspective view of a portion of a portable machining apparatus in operation, in accordance with one embodiment of the present invention;

FIG. 3 illustrates a perspective view of a base portion of a portable machining apparatus, in accordance with embodiments of the present invention;

FIG. 4 illustrates a perspective view of a top portion of a portable machining apparatus, in accordance with embodiments of the present invention;

FIG. 5 illustrates a perspective view of a rotary table, in accordance with embodiments of the present invention; and

FIG. 6 illustrates a perspective view of a process flow for repairing a part, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. A “user” as used herein may operate the present invention. The user may be defined as any person interacting with the present invention and may refer to a machinist, an engineer, an operator, or the like.

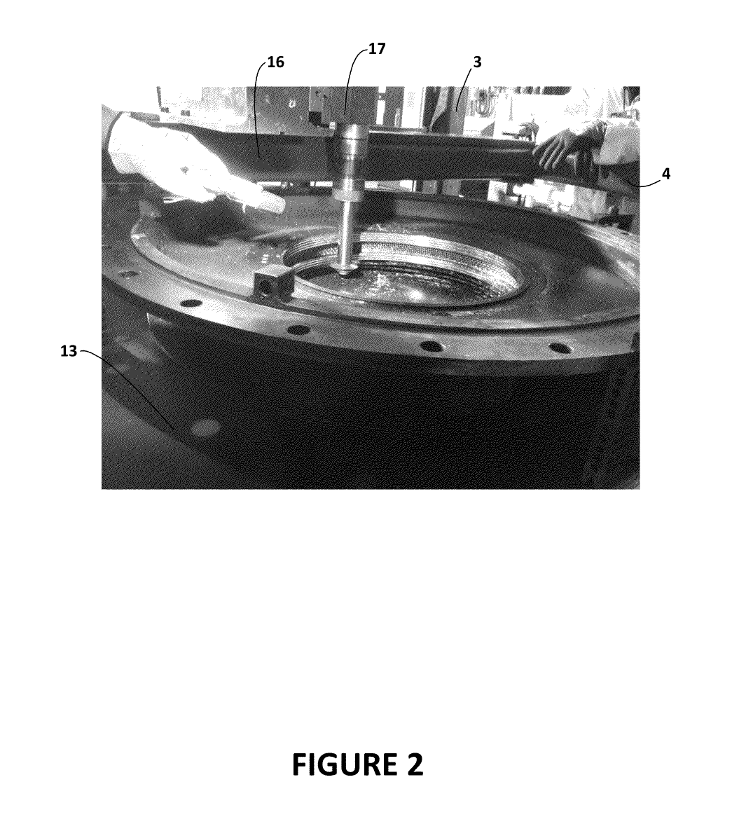

Large rotating equipment, such as a turbine in a power generation facility, a turbine engine, or other rotary machines used in other industries may need new seals or other parts that wear over time. These replacement parts often need to be machined to specific tight tolerances for specific applications, and thus off the shelf parts may require machining to fit particular applications. For example, turbines typically use oil seals to separate lubricated areas from non-lubricated areas, or to control the splatter or transfer of oil from one area to another in the turbine. A properly functioning oil seal may keep a lubricant (oil, a fluid, or the like) from leaking out of a lubricated area and from leaking into a non-lubricated area. The oil seal may be permanently machined into a housing, or otherwise be removable, and typically includes a plurality of grooves or “teeth.” Teeth on opposing parts (e.g., static seals and dynamic seals) act as a labyrinth seal to contain the lubricant in the lubricated areas. Oil seal teeth may be machined into equipment housing or a gland (e.g., a static shell of a turbine) or on replaceable seals that are coupled to the housings or glands, as depicted in FIG. 2. In some embodiments, a combination of teeth on the static housing coupled with groves or other teeth machined into a rotor, or a seal coupled to the rotor, create a labyrinth seal to prevent or reduce leakage of the lubricant. In other types of equipment, the labyrinth seal configuration may prevent or reduce the leakage of steam, hydraulic fluid, air, or other types of gas or liquids in various types of equipment. Over time with general use, machine upsets, normal wear and tear, or the like, the components (e.g., oil seal) may wear, become dislodged, damaged, or otherwise require replacement or repair. For example, a damaged oil seal may leak lubricant, lead to insufficient lubrication, and ultimately cause the equipment to fail, and thus may need to be replaced or repaired.

When the components of equipment fails, equipment owners may either choose to purchase new components or repair the existing components. Because the components are often large and expensive it may be costly to replace the equipment, and thus many equipment owners choose to repair the existing equipment. The equipment downtime, while components of the equipment are being repaired, may be expensive (e.g., equipment owner downtime cost can approach or exceed one million dollars per day) and as such equipment owners want components replaced or repaired as quickly as possible. Component repair or replacement often results in having to ship large components offsite for customized machining repairs, which may result in large shipping costs and equipment downtime. As described herein, the present invention uniquely provides the equipment owner with a cost-effective system for repairing existing equipment onsite.

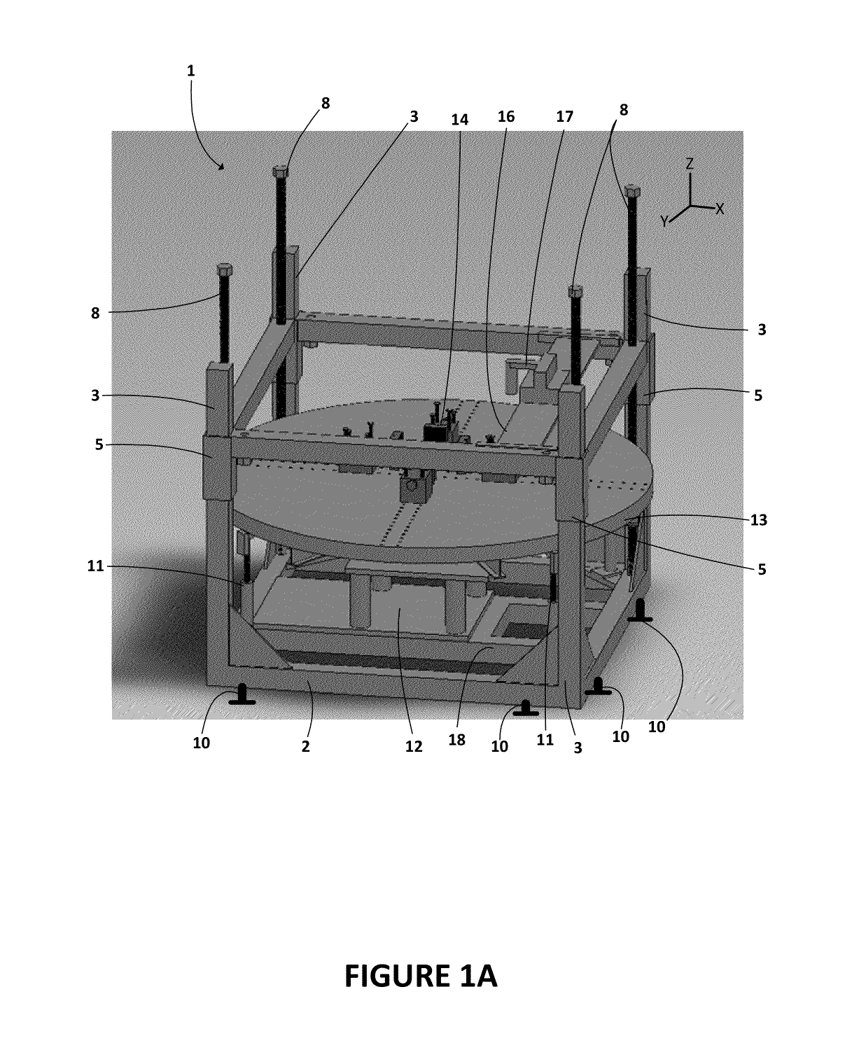

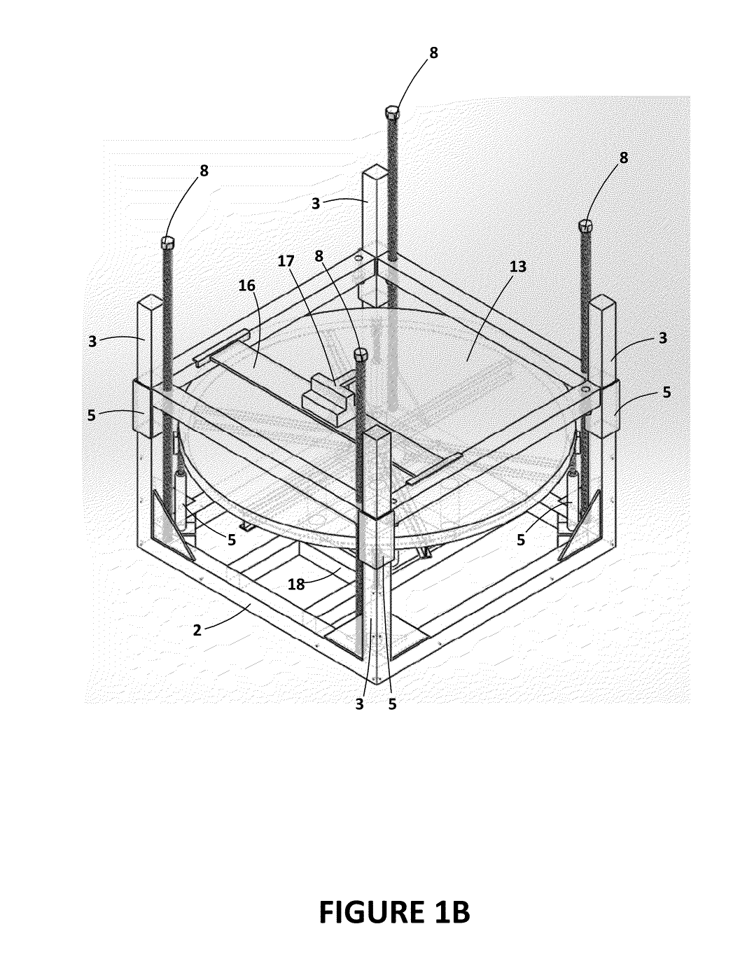

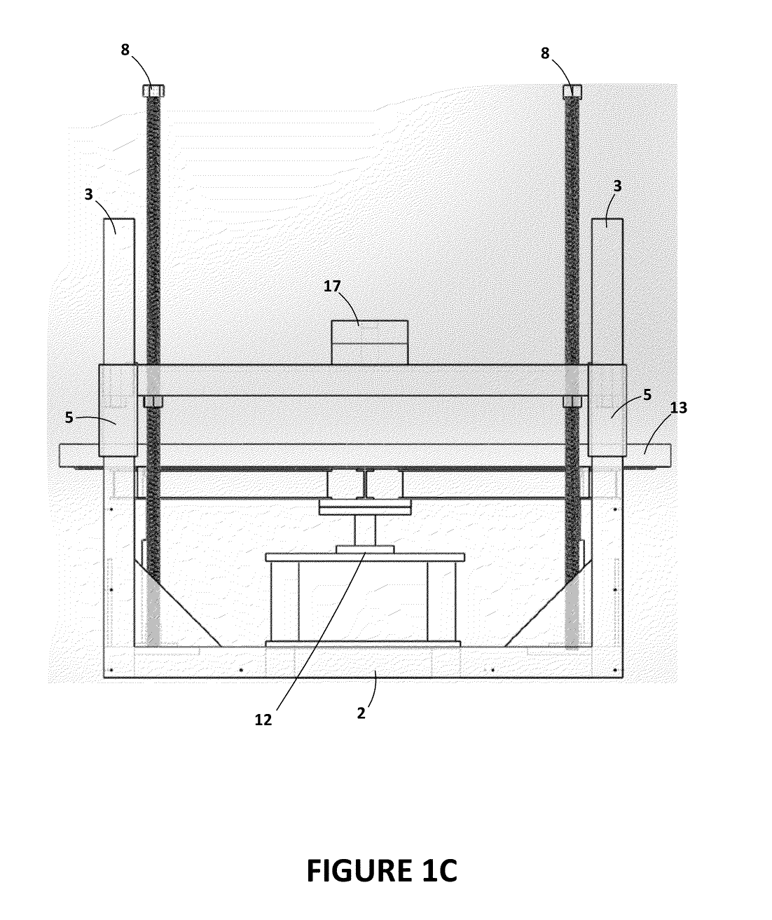

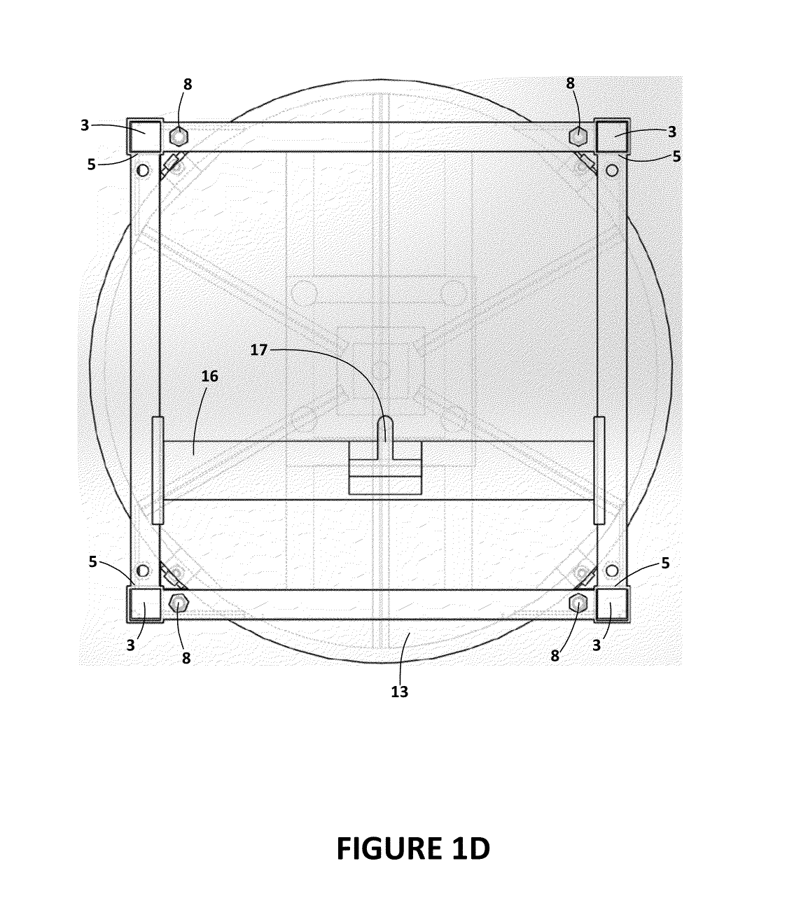

The present invention is a portable machining apparatus (e.g., portable oil seal machining apparatus) that is generally used to make circular cuts in a part, but otherwise may be adapted to machine parts in a number of various ways. The portable machining apparatus may be constructed from solid or hollow tubes (e.g., square, circular, or like shaped tubes) of steel, iron, aluminum, a composite material, or the like. The tubing may be bent, joined via weld couplings, mechanical couplings, or the like to form a frame 1 as depicted in FIG. 1.

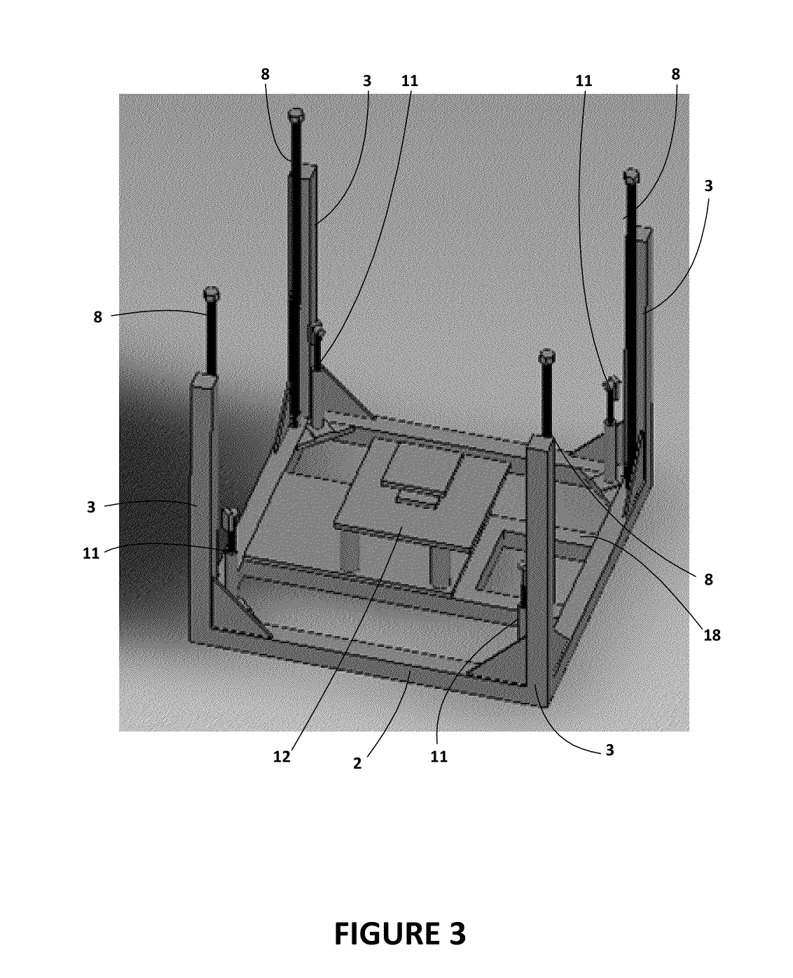

The frame 1 may include a base portion 2 (or a first portion) as shown in FIGS. 1A-1D, and 3. The base portion 2 may comprise a square or a rectangular base shape with four corners. In other embodiments the base may be triangular, circular, oval, hexagonal, octagonal, or any other like shape. At each of the four corners (or otherwise spaced apart at different intervals around the base portion 2 in other embodiments), one or more posts 3, which may be constructed from the same material as the frame 1, may be operatively coupled to and extend substantially orthogonally (or at acute or obtuse angles in other embodiments) from the base portion 2. The posts 3 may be permanently (e.g., welded, or the like) or detachedly (e.g., bolted, clamped, or the like) operatively coupled (e.g., directly coupled or coupled through another part) to the base portion 2 of the frame 1. In some embodiments, the base portion 2 may roughly resemble an inverted square table such that the “table top” surface is resting on the ground in the X-Y plane and the “table legs” are extending substantially vertically in the Z-plane. However, in alternative embodiments for example, the orientation of the base portion 2 may be in a different direction such that the posts 3 (e.g., “table legs”) extend in the X- or Y-directions.

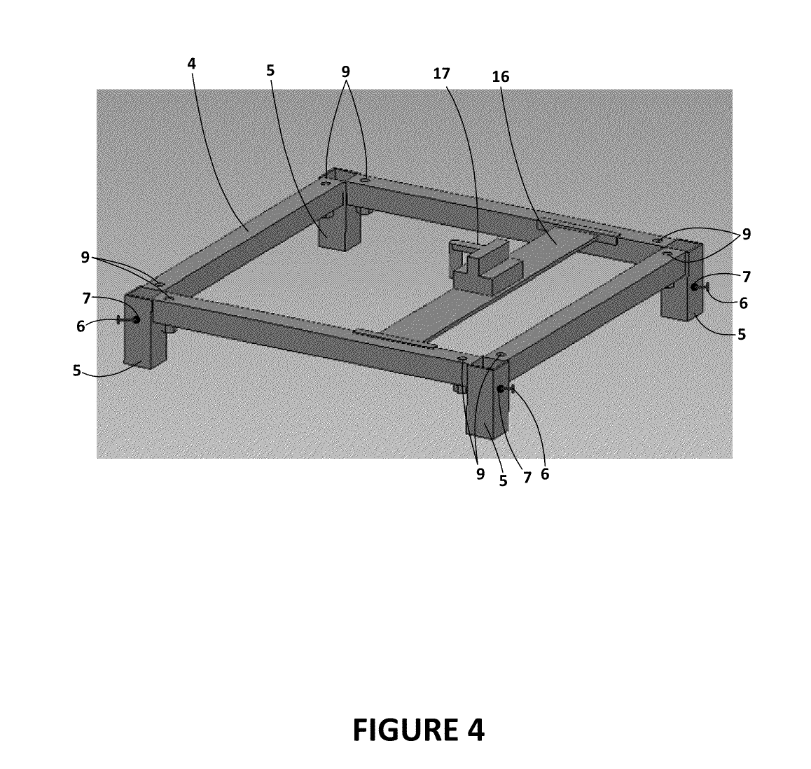

A top portion 4 (or a second portion), as pictured in FIGS. 1 and 4, may be operatively coupled to the base portion 2 via a one or more collars 5 (e.g., typically one collar 5 for each post 3) that receives the substantially vertical posts 3. The collars 5 may comprise a hollow cavity of a width that is at least the width of the posts 3, as such the posts 3 may slide into the collar cavities, and the collars 5 may completely or partially surround the posts 3. In one embodiment, in order to keep the top portion 3 stationary, the collars 5 may be coupled to the posts 3 via frame locks 6. These frame locks 6 (threaded bolts, pins, or the like) may be tightened or engaged to create frictional forces between the top portion's collars 5 and the posts 3, thus keeping the collars 5 from sliding up or down along the posts 3. In some embodiments, each collar 5 may be configured with one or more holes 7 (threaded or non-threaded) that receive the frame locks 6. Furthermore, the frame locks 6 may enable the top portion 4 to be securely adjusted at the desired height in order to allow for the machining of components of various sizes. In other embodiments the frame locks 6 may comprise adjustable stops that can be positioned relative the posts 3 (e.g., holes in the post 3 that utilize pins to set the height of the collars 5, locks that slide along the post 3 to set the height of the collars 5, or other like locking means). Adjustability of the top portion 4 may allow for the present invention to repair pieces of equipment that are variable in size. In other embodiments of the invention the collars 5 may be solid, or partially solid, and side into the posts 3, or otherwise, be operatively coupled to the post 3 to allow movement between the posts 3 and the collars 5.

In addition to, or as an alternative to the frame locks 6, the distance between the base portion 2 and the top portion 4 may be finely adjusted using a fine adjustment coupling. For example, in one embodiment the top portion 4 may be adjusted via threaded rods 8 that are permanently or detachedly operatively coupled to the base portion 2, such as to each corner of the base portion 2. In other embodiments the threaded rods 8 may be coupled at a location through the post 3, adjacent to the post 3, between the posts 3, or in other like locations. Typically, the threaded rods 8 extend substantially vertically in the Z-direction (e.g., in the vertical direction illustrated in the FIGS. 1A-1D) from the base portion 2, and thus, substantially parallel to the posts 3. The top portion 4 may include threaded holes 9 or nuts that accept the threaded rods 8. In this way, when the threaded rods 8 are turned clockwise or counterclockwise, the top portion 2 can be adjusted upwards or downwards along the threaded rods 8 at each location of the threaded rods 8. As such, the location of the top portion 4, which supports live tooling 17, may be adjusted at each individual fine adjustment means accordingly in order to adjust the position of the tooling for machining the component, as described in further detail later. The adjustments of the threaded rods 8 may be manually controlled or electrically controlled by a computer, computer numerical controls (CNC), linear measuring equipment, a motor or a drive, or other like controls. The threaded rods 8 and the poles 3 may act independently or together in stabilizing the adjustment of the top portion 4. In other embodiments of the invention, other fine adjustment couplings may be utilized, such as track and slide couplings, hydraulic or pneumatic couplings, or other like fine adjustment couplings. In other embodiments of the invention, the frame 1, such as the base portion 2 or the top portion 3, may be adjustable using threaded rods 8 in one or more of the X-direction, the Y-direction, or the Z-direction, or a combination thereof.

The base portion 2 may also include components for maintaining a level orientation. Adjustable feet 10 may be permanently or detachedly operatively coupled to the base portion 2 of the frame 1 to help keep the system level on a variety of onsite floor surface grades. Additionally, the base portion 2 of the frame 1 may include adjustable bearings 11 to maintain a level repair surface, such as the rotary table 13, which is described in further detail below. A combination of the adjustable feet 10 and the bearings 11 may ensure that the rotary table 13 is properly aligned and level for each specific machining operation. Moreover, the base portion 2 (or other portion of the portable machining apparatus) may also include transport couplings, such as forklift openings, cable openings, clamping locations, or the like that allow the portable machining apparatus to be moved through the use of a forklift, overhead crane, lift, or other like machinery.

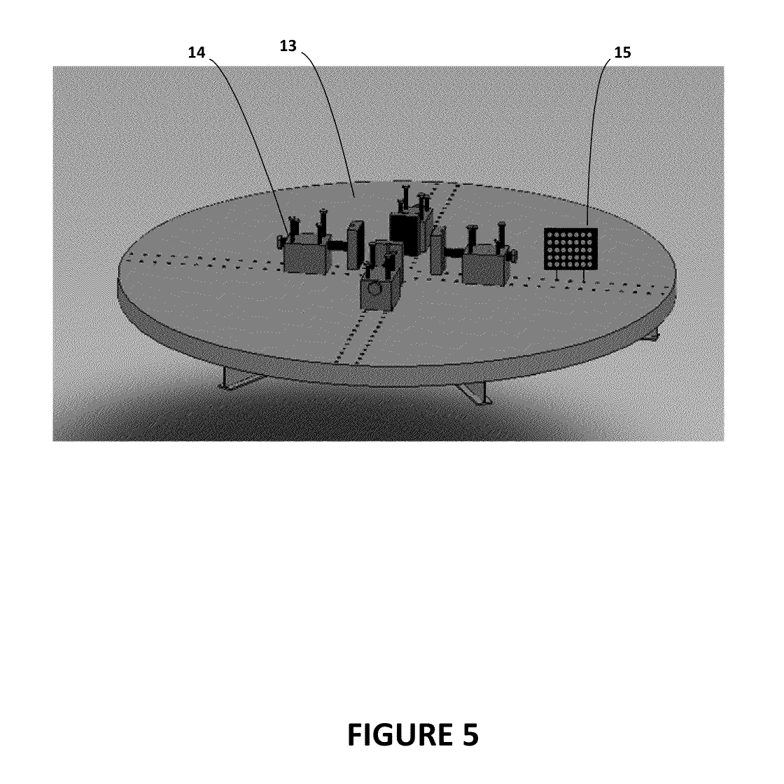

The rotary table 13 illustrated in FIGS. 1A-1D, and 5 is typically aligned in the X-Y plane to be flat within a specified tolerance, such that the present invention may have a smooth, straight, and level repair surface. However, in other embodiments, the rotary table 13 may be aligned in the X-Z plane, the Y-Z plane, or at a predetermined angle between the illustrated planes. The rotary table 13 may include a plurality of holes, pins, or other positional locators for attaching positioning tooling. For example, adjustable jaw chucks 14 may be installed for securing to and locating equipment on the rotary table 13. The jaw chucks 14 may be utilized to operatively couple a component, such as an oil seal, to the rotary table 13. The jaw chucks 14 may be positioned in predrilled holes in the rotary table 13, and furthermore, may include fine adjustment positioning mechanisms (e.g., adjustment screws) to position components within the desired tolerances. As such, components may be positioned stationary and located properly for machining. In other embodiments of the invention instead of, or in addition to the jaw chucks 14, the rotary table 13 may comprise a center attachment location (or radial located attachment locations) for the attachment of tooling that may be utilized to quickly position common components (e.g., a specific sizes of oil seals) to facilitate efficiency in the set up and machining operations of the portable machining apparatus. While the rotary table 13 typically accepts machine casings, housings, seals, or other types of components mounted concentrically to the rotary table 13 surface, the rotary table 13 may also be configured to accept machine casings or components mounted perpendicularly to the rotary table 13 surface. When machine casings or components are mounted perpendicularly to the rotary table 13 surface, an angle plate 15 may be installed on the rotary table 13 via the plurality of holes to ensure secure and aligned positioning. For example, while components, such as oil seals, may have the adjoining faces machined while lying in the X-Y plane, the components may also be oriented in the X-Z or Y-Z plane in order to machine the adjoining surfaces or flat surfaces of the components together.

Cross members 18, similar in construction to the frame 1, may be operatively coupled to the base portion 2 of the frame 1 to support a bearing drive 12. The bearing drive 12 may include a motor, hydraulics, pneumatics which, in some embodiments, may be manually or automatically controlled via CNC controls, computers, gears, levers or the like. In some embodiments, the bearing drive 12 may include variable speeds with controls of at least forward, reverse, variable speed, and stop. The purpose of the bearing drive 12 may be to enable the user to rotate the rotary table 13 for ease of alignment and machining.

A cross slide 16 may be permanently or detachedly operatively coupled to the top portion 4 of the frame 1. In some embodiments, the cross slide 16 may be adjustable along one or more axes. For example, in the illustrated embodiment in FIG. 4 the cross slide 16 may be slid along the top portion 4 of the frame 1 in one or more of the X-direction or the Y-direction. In other embodiments, the cross slide 16 may be rotatable around a center axis. In alternative embodiments, the cross slide 16 may be adjusted in another direction or at an angle. For example, the cross slide 16 may also be adjustable in the illustrated Z-direction with respect to the frame 1, in the same or similar way as was previously discussed with respect to the movement between the base portion 2 and the top portion 4. The cross slide 16 may be manually adjustable or automatically adjustable via a motor, electrical controls, CNC controls, hydraulics, pneumatics, or other like controls. Live tooling 17 may be operatively coupled to the cross slide 16. The live tooling 17 may serve as the cutting tool for the system.

The live tooling 17 may be adjustable in one or more of the X-axis, the Y-axis, or the Z-axis through either the movement of the frame 1 and/or the cross slide 16, or adjustable independently of the frame 1 and/or cross slide 16. Moreover, the live tooling 17 may include an angular adjustment so that cuts may be made at an angle in relation to the rotary table 13 cutting surface. For example, the live tooling 17 may also be moveable in one or more axes (X, Y, and Z) within the tooling itself. The maneuverability and adjustability of the live tooling 17 may enable the user to precisely cut a myriad of shapes with great precision. The speed of the live tooling 17 may be controlled manually or automatically by a computer-based system by using a motor, electronics, hydraulics, pneumatics, or other like control.

In one embodiment, the cross slide 16 is operatively coupled to the top portion 4 of the frame 1, and may be slid along two substantially parallel tubes of the top portion 4 so that the cross slide 16 is adjustable along one axis (e.g., the X-axis). The live tooling 17 may be coupled to the cross slide 16 so that the live tooling 17 is adjustable along the length of the cross slide 16 in another axis (e.g., the Y-direction). As needed, the top portion 4 of the frame 1 may be adjusted in another axis (e.g., the Z-direction) via the threaded rods 8. Ultimately, the combination of the X-axis adjustment of the cross slide 16, the Y-axis adjustment of the live tooling 17, and the Z-axis adjustment of the top portion 4 via the threaded rods 8 may enable the present invention to accept and allow for machining of components (e.g., oil seals) in a wide variety of sizes and shapes.

In other embodiments, the live tooling 17 may not only cut the outer diameter (OD), inner diameter (ID), teeth, and mating surfaces of oil seals (or other components) but it may also bore or drill holes into the oil seal. As such, the functionalities of the portable machining apparatus with the live tooling 17 may include drilling, boring, cutting, or the like. The live tooling 17 may be configured to repair a wide variety of materials including but not limited to metal, steel, iron, an alloy, aluminum, brass, copper, plastic, acrylic, or the like.

The live tooling 17 may also include a variety of cutting tool holders including but not limited to collet style, R30, R40, and R50, as well as a tooth straightener. The live tooling 17 may also include a drill or a mill head. The machining tools or tool holders may be swapped in and out of the live tooling 17 as needed to perform the various cuts required for various components on site in order to facilitate the efficient repair or replacement equipment components. Additionally, the live tooling 17 may include an electronic measuring system that communicates with a computer-based control system to provide accurate measurements and alignment of the live tooling 17. Hence, a combination of the adjustable frame 1 (and its associated alignment components), the driven rotary table 13, and the live tooling 17 may enable the present invention to be utilized for a variety of onsite machining services.

In some embodiments, the present invention may be used to repair a damaged split joint of a component (e.g., the mating faces of an oil seal, a joint along the horizontal length of a turbine housing where a top half section of the machine casing and a bottom half section of the machine casing are joined, or other like split face). If the split joint has been damaged or requires resizing before use to prevent or reduce fluid or gas (e.g., oil) leakage, the present invention may be configured to cut a new split joint, or otherwise square the surface of the split joint. This process may be done in the X-Y plane as illustrated in FIG. 2, however in other embodiments a component may be perpendicularly mounted on the rotary table 13 via an angle plate 15, the live tooling 17 may accurately align to the split joint of the component. The split joint may then be cut flat using the live tooling 17 to achieve a proper seal for the split joint. Once a sufficient cut has been made within the desired tolerance ranges, the two halves of the component (e.g., oil seal or other component) may be assembled together and mounted concentrically on the present invention for additional machining.

In other embodiments, the present invention may employ live tooling 17 for cutting an inner diameter or an outer diameter of a component (e.g., the ID of a seal surface, the OD of a seal surface, surface on a rotor, surface on a housing, or the like). Tight tolerances may be required on particular components, and as such, the present invention may be accurate in its machining precision. Precision measurement tools may be incorporated into the portable machining apparatus, or otherwise, used in conjunction with the portable machining apparatus. For example, the amount of material that may typically be removed from a component (e.g., an ID of an oil seal) by the live tooling 17 ranges between one-eighth to one-fifth of an inch, while the precision of the machining of a surface (e.g., the ID of the oil seal) may be cut to within plus or minus five thousandths of an inch (or less or more) of the specified dimension. The teeth of an oil seal may also require these precision cuts. The adjustable frame 1, rotary table 13, and live tooling 17 may enable many sizes and shapes of components, particularly oil seals to be cut. For example, the sizes of oil seals or other components that may be machined on the portable machining apparatus may range from and ID of two inches to thirty inches and an OD of four inches to eighty inches. The dimensional ranges discussed herein may fall within, overlap, or fall outside of the stated ranges.

In the illustrated example of machining oil seals, once the seal faces and diameters are cut, the present invention may be utilized for boring or profiling oil seal teeth. Oil seal teeth may refer to grooves or ridges on an insertable replacement seal or on a seal machined into a housing seal, which may be a static seal or a dynamic seal. The teeth of a seal may work in conjunction with a flat surface, a surface with grooves in it, or other teeth to prevent or reduce oil or other liquids or gases from leaking between areas or components of equipment. The teeth may be shaped by the live tooling 17 according to predetermined dimensions (e.g., a diameter or a profile of oil seal teeth) that may be specified by the user to meet the requirements of each project.

In alternative embodiments, in addition to machining teeth, the present invention may be used to cut reliefs in the teeth or oil drains to help control the lubricant flow and distribution throughout the equipment. Lastly, the profile of the components may be examined and measured for accuracy. The completed component may then be inspected, cleaned, and polished as needed.

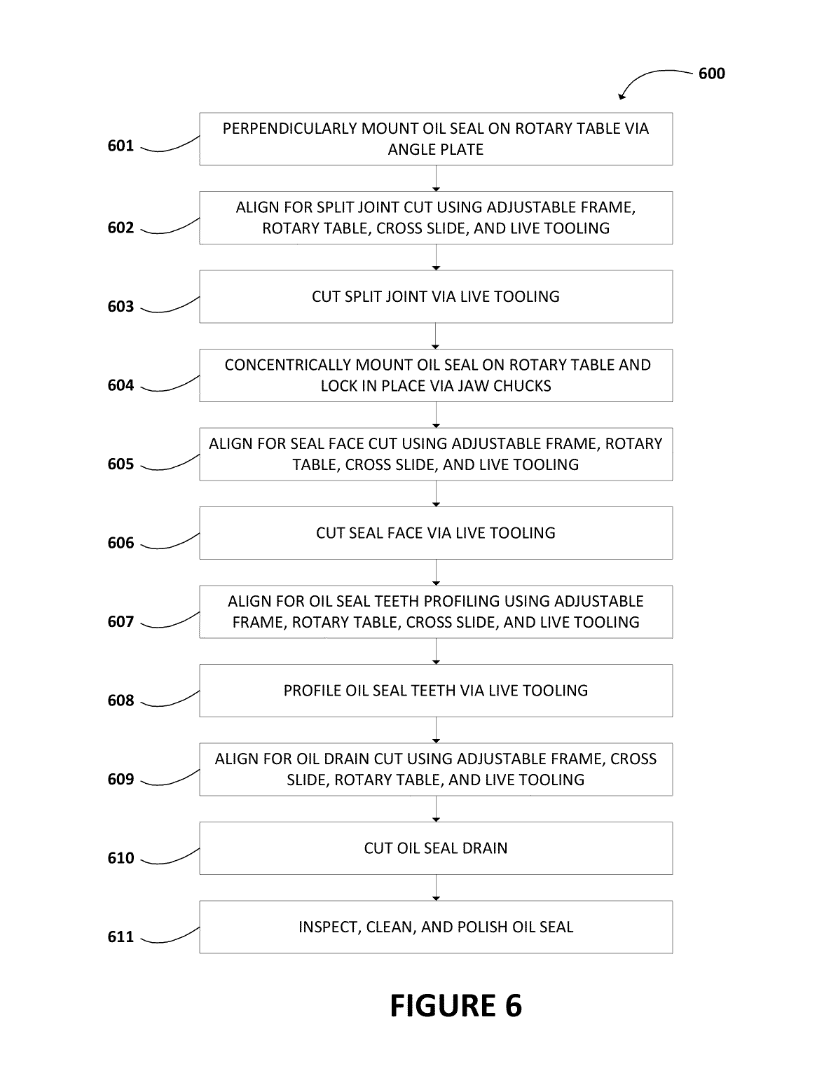

FIG. 6 illustrates a process flow 600 for executing machining via the present invention. At block 601, the process includes perpendicularly (e.g., horizontally) mounting an oil seal on the rotary table 13 via the angle plate 15. At block 602, the process includes aligning for a split joint cut using the adjustable frame 1 (and its associated components such as the base portion 2, the posts 3, the top portion 4, the collars 5, the frame locks 6, the collar holes 7, the threaded rods 8, the threaded holes 9, the adjustable feet 10, and the bearings 11), the rotary table 13 (and its associated bearing drive 12), the cross slide 16, and the live tooling 17. This step includes assembling the tooling and tool holders in the live tooling 17 to make the desired cut. At block 603, the process includes cutting the split joint via the live tooling 17. In other embodiments of the invention the split joint cut may be made with the oil seal in the X-Y plane (e.g., horizontally on the rotary table 13). At block 604, the process includes concentrically (e.g., vertically) mounting the oil seal on the rotary table 13 and locking it into place via the jaw chucks 14, or other type of alignment tooling. At block 605, the process includes aligning the portable machining apparatus for a seal face (e.g., ID or OD) cut using the adjustable frame 1, the rotary table 13, the cross slide 16, and the live tooling 17. This step includes assembling the tooling and tool holders in the live tooling 17 to make the desired cut. At block 606 the process includes cutting the seal face via the live tooling 17. At block 607, the process includes aligning the portable machining apparatus for oil seal teeth profiling using the adjustable frame 1, the rotary table 13, the cross slide 16, and the live tooling 17. This step includes assembling the tooling and tool holders in the live tooling 17 to make the desired cut. At block 608, the process includes profiling the oil seal teeth via the live tooling 17. At block 609, the process includes aligning for an oil drain cut using the adjustable frame 1, the rotary table 13, the cross slide 16, and the live tooling 17. Again, this step includes assembling the tooling and tool holders in the live tooling 17 to make the desired cut. At block 610, the process includes cutting the oil seal drain. At block 611, the process includes inspecting, cleaning, and polishing the oil seal.

The present invention's portability may enable the repair of equipment to occur onsite. This may ultimately save the equipment owner time and money. In some embodiments, the present invention may be moveable via a forklift, a crane, or the like. Furthermore, while an oil seal is used in many aforementioned examples, the present invention may be configured to accept and repair a myriad of equipment, machinery, or the like. A wide variety of materials may be cut or repaired by the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

What is claimed is:

1. A portable machining apparatus comprising:
a frame,
a rotary table operatively coupled to the frame;
a cross slide operatively coupled to the frame; and
wherein the cross slide is configured for operative coupling to live tooling, wherein the live tooling may be adjustable in one or more axes by adjusting the frame or the cross slide for machining a component secured to the rotary table.

2. The apparatus of claim 1, wherein the frame comprises a base portion and a top portion that are adjustable with respect to each other in a vertical axis.

3. The apparatus of claim 1, wherein the frame comprises adjustable feet.

4. The apparatus of claim 1, wherein the frame is operatively coupled to a bearing drive for adjusting the rotary table.

5. The apparatus of claim 2, wherein the base portion comprises a plurality of posts extending substantially vertically from the base portion.

6. The apparatus of claim 5, wherein the top portion comprises a plurality of collars that are operatively coupled to the plurality of post for sliding in the generally vertical direction.

7. The apparatus of claim 6, wherein the plurality of collars comprises a plurality of frame locks for securing the top portion to the base portion.

8. The apparatus of claim 7, wherein the plurality of frame locks comprises a pin or a threaded bolt that makes engages the post.

9. The apparatus of claim 2, wherein the frame further comprises frame adjustments that are operatively coupled to, and extend substantially vertically from, the base portion, and are operatively coupled to the top portion to allow for adjustability of the top portion with respect to the base portion in the vertical direction.

10. The apparatus of claim 9, wherein the frame adjustments comprise threaded rods.

11. The apparatus of claim 1, wherein the rotary table comprises a plurality of jaw chucks to secure the component.

12. The apparatus of claim 1, wherein the rotary table comprises an angle plate to secure the component.

13. The apparatus of claim 1, wherein the cross slide is adjustable along at least one axis of the top portion of the frame.

14. The apparatus of claim 1, wherein the live tooling is adjustable along at least one axis with respect to the cross slide.

15. The apparatus of claim 1, wherein the live tooling comprises an adjustment in one or more axes.
